(19) United States
(12) Patent Application Publication
(10) Pub. No.: US 2012/0103366 A1
(43) Pub. Date: May 3, 2012

(54) METHOD FOR CLEANING A DUEL MODE OVEN

(75) Inventors: Yves LUBRINA, Chaussenans (FR); Fabrice LAGET, Arbois (FR)

(73) Assignee: THIRODE GRANDES CUISINES POLIGNY, Poligny (FR)

(21) Appl. No.: 13/223,034

(22) Filed: Aug. 31, 2011

(30) Foreign Application Priority Data
Oct. 28, 2010 (FR) 1058921

(51) Int. Cl. B08B 9/00; B08B 3/04; B08B 7/04

(52) U.S. Cl. 134/18; 134/22.1

(57) ABSTRACT

According to the invention, the method for cleaning a dual cooking mode oven, comprising a muffle forming the cooking enclosure, and a boiler for sending water, as vapour, inside the enclosure of the muffle, is characterized in that the washing step of the muffle and the descaling step of the boiler are carried out in parallel, simultaneously.

The present invention relates to a method for cleaning a dual mode oven adapted for cooking food products, providing [symbol] dry and/or vapour [symbol] cooking modes.

Generally speaking, such a dual mode cooking oven essentially comprises a muffle defining the enclosure inside which the food products are cooked by a source of heat (gas, electricity), and a boiler containing water and driving the latter, in the form of vapour, in the muffle.

After the oven has been used, it should be cleaned. To this end, several cleaning modes are associated with the oven and more specifically comprise different program levels consuming, depending on that being selected, more or less water, with more or less variable temperatures and durations depending on the fouling extent of the oven. The cleaning product, for example, for the washing-degreasing/-rinsing for the cooking enclosure of the muffle could be introduced as tablets, degradable powder sachets or as a liquid product. After the muffle has been washed/degreased, for treating the greasy residues and others, it is to be descaled, as well as the boiler for treating limestone deposits and similar, through introducing tablets or liquid products being specific to dissolve limestone deposits and other similar residues.

It is thus obvious that the cleaning procedure for such a dual mode oven successively implementing cleaning the muffle, followed by descaling the boiler and the muffle, leads to a standstill of the oven for a large period of time, to which there could be added washing and rinsing the boiler.

The aim of the present invention is to remedy these drawbacks.

To this end, the method of this invention for cleaning a dual mode cooking oven, comprising at least one muffle forming the cooking enclosure of the oven and a boiler for circulating water, as vapour, inside the enclosure of the muffle, is remarkable in that the washing step for the muffle and the descaling step for the boiler are performed in parallel, simultaneously.

As known, such a dual mode oven comprises a muffle and a boiler and thus four steps (washing and descaling) should be applied to such both members for a full cleaning.

It could thus be wanted to implement the integration according to a large combination of six or eight step solutions. A first removal could only consist in maintaining two simultaneous maximum steps, so that only two solutions would be remained.

That of this invention is all the more original as it is based on a situation that would prevail if this invention had not been provided. Indeed, deciding to wash the muffle in parallel and descaling the boiler is particularly of interest when the muffle is not required to be descaled, as, in such a case, cleaning of the assembly occurs in one single “time step”. This somewhat contradictory aspect imparts to the method of this invention its inventive activity, such as required by the law.

Thus, according to this invention, through simultaneously carrying out the steps comprising washing the muffle and descaling the boiler, and if, in addition, the washing and descaling step is automated, time is considerably saved, leading to the oven having to standstill for a shorter period of time. Indeed, after experiment, it seems that after being used, descaling the muffle is not as often necessary as that of the boiler becoming more rapidly scaled, as it is constantly filled with water (storing) and produces vapour (heating) resulting in limestone deposits being more or less rapidly formed, depending more specifically on the water hardness.

Other features and advantages of the cleaning method will become obvious, considering the figures of the appended drawing, and the following description that will make well understand how this invention could be implemented.

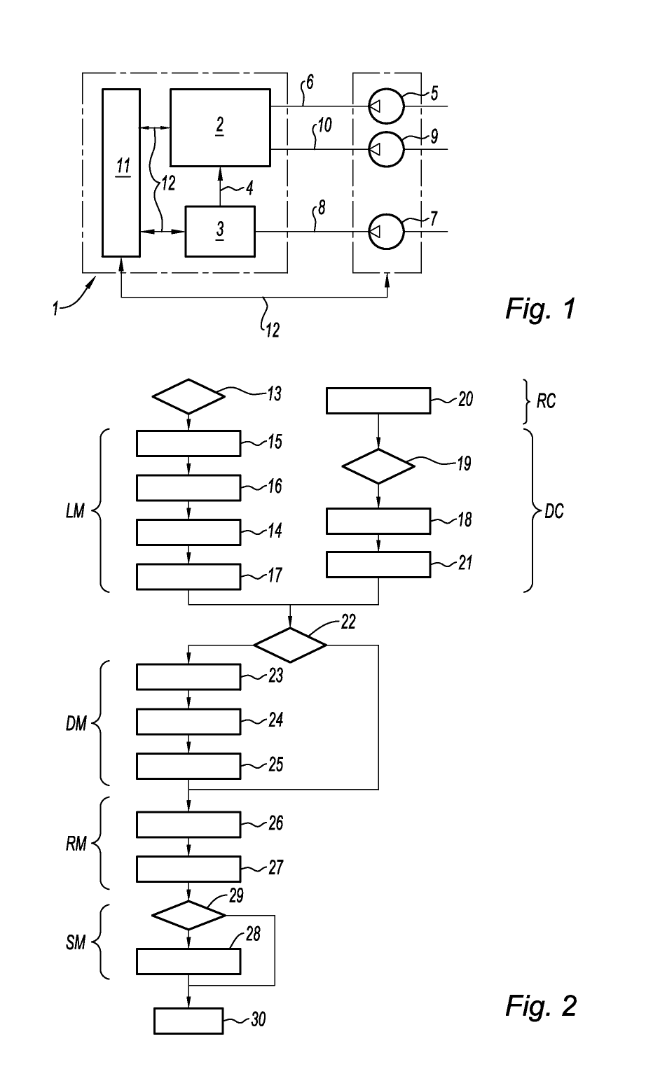

FIG. 1 is a block diagram of a dual mode oven and of the associated cleaning equipment.

FIG. 2 is an exemplary flow diagram for carrying out the steps of the cleaning method according to this invention.

The dual mode oven 1, schematically and symbolically shown on FIG. 1, is to be used for cooking food products in dry cooking, vapour or dual (dry+vapour) modes and, to this end, it comprises a muffle 2 defining the cooking enclosure of the food products and a boiler 3 containing water and able to be put in communication, via a link 4, with the enclosure of the muffle upon a vapour or dual mode cooking.

In order to carry out cleaning the oven according to the method of the invention, different equipment items are provided to this end. A pump 5 is connected via a link 6 to the muffle 2 for supplying, from an upstream storing tank, not shown, a washing-degreasing product in the enclosure of the muffle 2. A pump 7 is connected, via a link 8, to the boiler 3 for supplying, from an upstream storing tank, not shown, a descaling product in the boiler 3, and a pump 9 is connected, via a link 10, to the muffle 2 for supplying, from an upstream storing tank, not shown, a descaling product in the enclosure of the muffle 2. The storing tank for descaling the muffle could be the same as that necessary to the boiler.

A programmable central unit 11 associated with the oven 1 manages, in addition to the different cooking modes, the temperatures, times, etc. the cleaning cycles for the muffle and the boiler as a function of various parameters or instructions associated with the use duration of the latter, the size of the oven, the water flow rate, the water consumption, the water hardness, etc. and it determines, consequently, the actuation of the pumps and other associated members (solenoid, valves, . . . ) via a link 12 symbolizing the various information being exchanged (inlets-outlets) between the unit and the pumps, the muffle and the boiler.

When it is determined that the muffle 2 and the boiler 3 are to be cleaned from the unit 11 (or through a deliberate choice), the cleaning method is implemented as shown on FIG. 2. According to this invention, the method consists in carrying out in parallel washing the muffle 2 and descaling the boiler 3.

To this end, via the unit 11, the pumps 5 and 7 are actuated and send washing and descaling products, according to the predetermined wanted amounts, as a function of the recorded fouling and descaling condition, in the enclosure of the muffle and in the boiler, respectively.

As such operations have large durations, carrying them out simultaneously and separately one from the other, strongly reduces the duration of the cleaning cycle of the oven 1 and, thus, restricts the “inactivity” thereof.

Prior to washing, a logic gate 13 confirms that the muffle is at the appropriate temperature before initiating the cycle.

Washing the muffle LM actually comprises, in addition to the washing step 14 as such, a prewashing step 15 followed by a water heating step with introduction of the washing product 16 through the pump 5. Then, after the washing step 14, a prerinsing step 17 is provided, so as to complete washing the muffle LM and to discharge at the best the deposits and washing products as well as water being used, contained in the enclosure of the muffle 2.

Simultaneously, but separately from washing LM the latter, the boiler DC is being descaled, in a descaling step 18 triggered by the actuation of the pump 7 supplying the appropriate product. Prior to this descaling step, a logic gate 19 has validated via the unit 11 descaling DC. Upstream this gate, the boiler RC is rinsed by a specific step 20 enabling to remove the deposits and the slurries being present in the boiler.

Further to the descaling step 18, a step 21 is carried out, successively comprising neutralizing, emptying and rinsing the descaled boiler 3.

Washing the muffle LM and descaling the boiler DC then occur with the above mentioned advantages.

At that time, the following alternative is present, as given by a logic gate 22: either the muffle DM is descaled, or the muffle RM is rinsed. Such an alternative is solved as a function of the scaling extent of the muffle 2 which, as previously stated, is less frequent than that of the boiler.

If, after the yes-no logic gate 22, descaling the muffle DM is validated, and thus, should be carried out, the method of this invention successively comprises a step involving heating water 23 then supplied into the muffle 2, followed by a descaling step as such 24 triggered by the pump 9, followed by a neutralizing-emptying-rinsing step 25. The steps, as the other nevertheless, are automatically managed by the unit, but could be manually triggered, if necessary. Then the cleaning cycle continues with the descaled muffle RM being rinsed.

If, at the outlet of the gate 22, descaling the muffle DM is not validated, then rinsing the muffle RM is directly carried out in a heating water step 26 followed by a rinsing step 27.

After the muffle RM has been rinsed, the latter is dried SM in a final drying step 28, if this is found to be necessary via a yes-no logic gate 29.

The cleaning cycle of the oven 1 is then completed and symbolized on FIG. 2 by the rectangle 30 displayed, for example, on the oven 1.

Thus, using the method of this invention, the oven cleaning duration is reduced, and, thus, the standstill thereof, while integrating in parallel descaling the boiler and washing the muffle, processing them at the same time, but separately and in an automated way by the unit, depending on the scaling extent of the oven being determined by the above mentioned parameters. And only if this is necessary, descaling the muffle is carried out. The scaling extent is carried out separately (boiler and enclosure) for evaluating how relevant it is not to descale anything, to only descale the boiler (or only the muffle) or to descale both of them.

The user is actually aware of the present situation, the method enabling to reduce the intervention times and, furthermore, an optimized water consumption through associated descaling and rinsing operations.

1. A method for cleaning a dual cooking mode oven, comprising a muffle forming the cooking enclosure, and a boiler for sending water, as vapour, inside the muffle enclosure,
characterized in that the washing step of the muffle and the descaling step of the boiler are carried out in parallel, simultaneously.

2. A method according to claim 1, wherein, after the boiler has been descaled, a neutralizing, emptying and rinsing step thereof is carried out.

3. A method according to claim 1, wherein, after the muffle has been washed, a prerinsing step of the latter is carried out.

4. A method according to claim 1 wherein, prior to the washing step of the muffle and the descaling step of the boiler, a prewashing step of the muffle and a rinsing step of the boiler are respectively carried out.

5. A method according to claim 1, wherein, after the washing step of the muffle, a descaling step of the latter is carried out.

6. A method according to claim 5, wherein the descaling step of the muffle is followed by a neutralizing, emptying, rinsing steps of the latter.

7. A method according to claim 1, wherein, after the washing or descaling step of the muffle, a rinsing step of the latter is carried out.

8. A method according to claim 7, wherein a final drying step of the muffle is carried out, before the oven is switched on again.

9. A method according to claim 1, wherein the washing and descaling steps for the muffle and for the boiler are carried out by respective pumps for each step.

10. A method according to claim 1, wherein a programmable central unit being connected to the muffle and to the boiler and containing information relating to the actuation thereof, manages, in a automated way, the cleaning cycle of the oven.
